(19) United States
(12) Patent Application Publication
(10) Pub. No.: US 2015/0074005 A1
(43) Pub. Date: Mar. 12, 2015

(54) Method and apparatus for facilitating patent searching

(71) Applicants: William C. Brougher, Menlo Park, CA (US); Doug Banks, Redwood City, CA (US)

(72) Inventors: William C. Brougher, Menlo Park, CA (US); Doug Banks, Redwood City, CA (US)

(21) Appl. No.: 11/787,918

(22) Filed: Apr. 17, 2007

Related U.S. Application Data
(60) Provisional application No. 60/874,707, filed on Dec. 12, 2006.

(51) Int. Cl. G06F 17/30; G06F 17/00; G06Q 50/00

(52) U.S. Cl. 705/311

(57) ABSTRACT

One embodiment of the present invention provides a system that displays a patent. This system provides a user interface, which is configured to display panels containing different sections of the patent, wherein the panels for the different sections of the patent are visible at the same time. In this way, a user does not have to navigate to view the different sections of the patent. In a variation on this embodiment, the panels for the different sections of the patent can include: (1) a patent summary panel, which displays the abstract of the patent and also displays information associated with the patent, including: the patent number, the filing date, the issue date, the names of the inventors and the assignee; (2) a citations panel which displays documents which are cited by the patent; and (3) a claims panel which displays one or more claims in the patent.

### RELATED APPLICATION

This application hereby claims priority under 35 U.S.C. §119 to U.S. Provisional Patent Application No. 60/874,707, filed on 12 Dec. 2006, entitled “Method and Apparatus for Facilitating Patent Searching,” by inventors William C. Brougher and Doug Banks.

### BACKGROUND

1. Field of the Invention

The present invention generally relates to the field of information retrieval. More specifically, the present invention relates to a system that facilitates efficiently searching through patent-related documents.

2. Related Art

The relentless growth of the Internet has been largely fueled by the development of sophisticated search engines, which enable users to easily comb through billions of web pages looking for specific pages of interest. Although such search engines are well-suited for searching through web pages, they are not well-suited for searching through certain types of documents, such as patents, which have a specific format and which are searched in very specific ways.

There exist a number of web sites that enable users to browse through patent-related documents, but none of these web sites provide this capability through user interface which is both intuitive and easy-to-use.

Hence, what is needed is a method and an apparatus that facilitates searching for patent-related documents without the shortcomings of existing systems.

### SUMMARY

One embodiment of the present invention provides a system that displays a patent. This system provides a user interface, which is configured to display panels containing different sections of the patent, wherein the panels for the different sections of the patent are visible at the same time. In this way, a user does not have to navigate to view the different sections of the patent.

In a variation on this embodiment, if less than a specified amount of data would appear in the panels, the display is configured to present a scanned version of the front page of the patent instead of the panels.

In a variation on this embodiment, a panel is a contiguous two-dimensional region in the display which can have any shape.

In a variation on this embodiment, the panels for the different sections of the patent can include: (1) a patent summary panel, which displays the abstract of the patent and also displays information associated with the patent, including: the patent number, the filing date, the issue date, the names of the inventors and the assignee; (2) a citations panel which displays documents which are cited by the patent; and (3) a claims panel which displays one or more claims in the patent. Note that one or more of the panels can be dynamically configured to facilitate presentation. For example, a panel for a particular section of a patent can be sized to display all of the content in the section. On the other hand, if there is no content in the section, then the panel can be eliminated from the display.

In a further variation, the citations panel displays the cited documents in ranked order, wherein each cited document is ranked based on a number of references to the cited document.

In a variation on this embodiment, the display also includes links to corresponding sections in a scanned version of the patent, wherein the sections include: the abstract, the description, and the claims of the patent.

In a variation on this embodiment, the display includes a search box for the patent, which allows a user to enter a query to search for specific terms in the patent.

In a variation on this embodiment, the display includes a link to a related document at a patent office web site. In a further variation, the link to the related document can be: a link to a corresponding version of the patent at the patent office website; or a link to an entry for the patent on the public PAIR system at the patent office website.

In a variation on this embodiment, the layout includes a drawings section which displays thumbnail versions of the drawings in the patent. When a user selects on a thumbnail version of a drawing, the user interface displays an expanded version of the drawing.

In a variation on this embodiment, the layout includes a “referenced-by section,” which displays other patents and other related documents which reference the patent.

One embodiment of the present invention provides a system that facilitates searching through patent-related documents. This system includes a patent database which contains patent related documents. It also includes a user interface, which provides a search box through which the user can enter a query containing search terms. The system additionally includes a searching mechanism, which is configured to process the query by searching in the patent database for matching patents which contain the search terms, and to display any matching patents. If the searching mechanism cannot find a patent containing a search term, and if the search term is similar to a term which appears in one or more patents, the searching mechanism is configured to suggest that the similar search term be used in place of the search term in a subsequent query.

In a variation on this embodiment, if a user selects a matching patent, the user interface is configured to highlight the search terms while displaying the matching patent.

### BRIEF DESCRIPTION OF THE FIGURES

FIG. 1 illustrates a patent searching system in accordance with an embodiment of the present invention.

FIG. 2 presents a flow chart illustrating the patent searching process in accordance with an embodiment of the present invention.

FIG. 3 presents a flow chart illustrating the process of displaying a patent in accordance with an embodiment of the present invention.

FIG. 4 illustrates an about-this-patent page in accordance with an embodiment of the present invention.

FIG. 5 illustrates a front page of a patent in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Patent Searching System

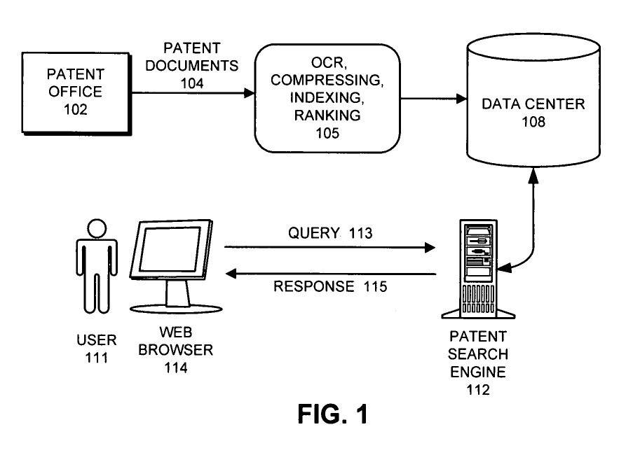

FIG. 1 illustrates a patent searching system in accordance with an embodiment of the present invention. The patents which are searched originate at a patent office 102, such as the United States Patent & Trademark Office or another national patent office, such as the European patent office. Alternatively, the patents can be obtained from a patent service such as Micropatent M. More specifically, patent documents 104, such as issued patents and published applications, are transferred from patent office 102 to a processing module 105, which performs a number of operations on the patent documents, such as optical character recognition (OCR) operations and compression, indexing and ranking operations. Note that the patent documents can include bitmap images of the patent documents, as well as other types of patent metadata provided by patent office 102, such as serial numbers and filing dates. The processed documents are then stored in data center 108.

During a subsequent searching process, a patent search engine 112 receives a query 113 from a user 111 through a web browser 114. This query 113 specifies a number of terms to be searched for in the patent documents. In response to query 113, search engine 112 uses search terms specified in the query to identify patents that satisfy the query. Search engine 112 then returns a response 115 through web browser 114, which includes a list of matching patents, along with references to the identified patents and possibly includes ranking information.

### Patent Searching Process

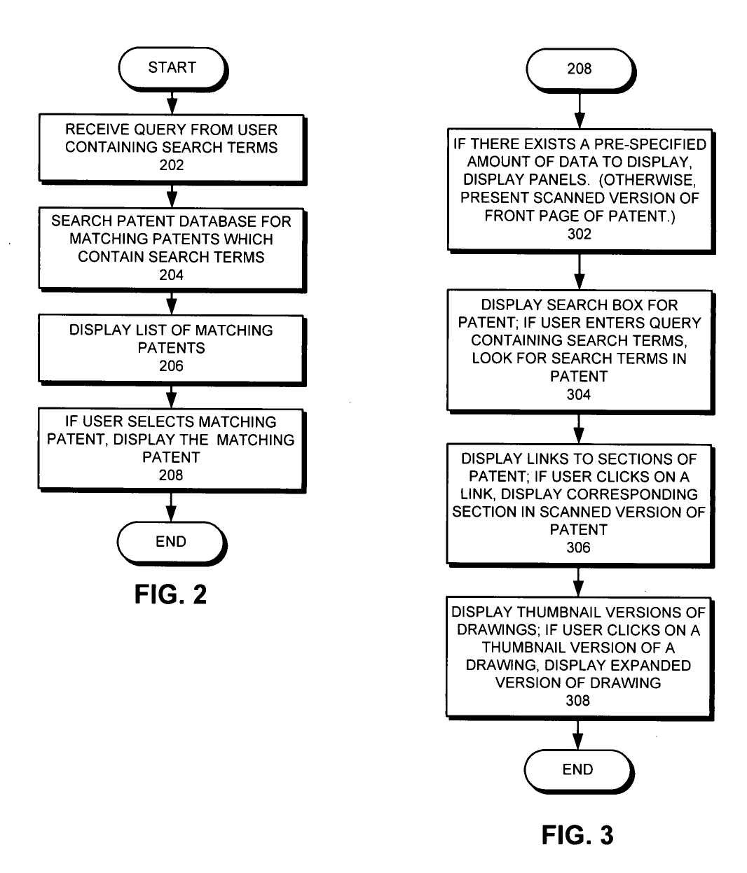

FIG. 2 presents a flow chart illustrating the patent searching process in accordance with an embodiment of the present invention. During this process, the patent search engine receives a query containing search terms from a user (step 202). Next, the patent search engine searches the patent database to identify patents which contain the search terms (step 204). If such matching patents are identified, the system displays a list of the matching patents (step 206). Finally, if a user selects a matching patent, for example by clicking on a link to the matching patent, the system displays the patent (step 208). This process is described in more detail below with reference to FIG. 3.

In one embodiment of the present invention, if the search engine cannot find a patent containing a search term, and if the search term is similar to a term which appears in one or more patents, the search engine is configured to suggest that the similar search term be used in place of the original search term in a subsequent query. Alternatively, if the search engine cannot find a patent, the system can enable the user to search the patent office web site to find the patent because the patent office web site may contain some recently issued patents that have not yet been loaded onto the patent database.

In one embodiment of the present invention, if a user selects a matching patent, the user interface is configured to highlight the search terms while displaying the matching patent.

### Displaying a Patent

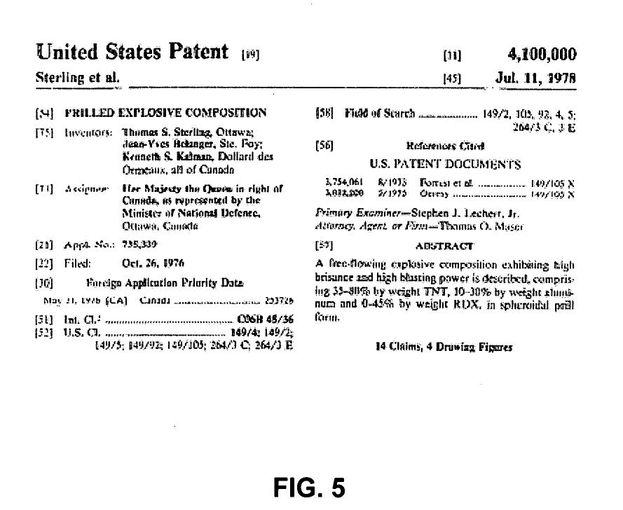

FIG. 3 presents a flow chart illustrating the process of displaying a patent in accordance with an embodiment of the present invention. The process starts by examining how much data there is to display for the patent. If a pre-specified amount of data exists to display for the patent, the system is configured to display an “about-this-patent page,” which contains panels for different sections of the patent (step 302). These panels for the different sections are visible at the same time, so that a user does not have to navigate to view the different sections of the patent. Otherwise, if less than the pre-specified amount of data exists, the system presents a scanned version of the front page of the patent (such as appears in FIG. 5) instead of the panels.

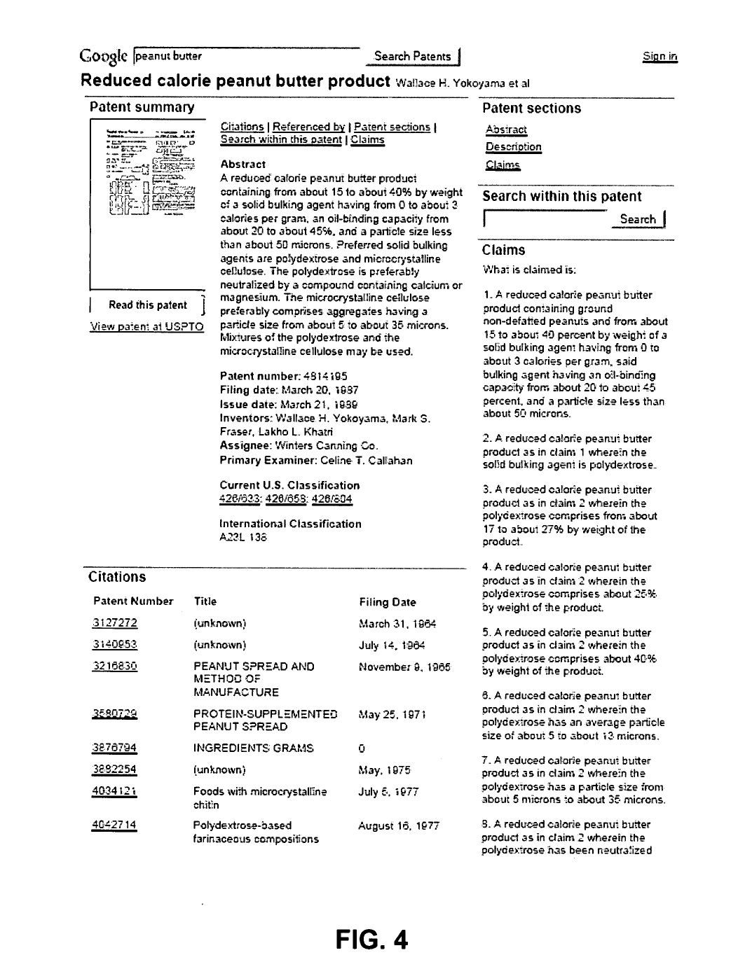

An exemplary layout for an about-this-patent page appears in FIG. 4. Note that this layout includes a patent-summary panel, which displays the abstract of the patent and also displays information associated with the patent, including: the patent number, the filing date, the issue date, the names of the inventors and the assignee, the Primary Patent Examiner and various classification information. Also note that we can use a double-column layout as shown in FIG. 4 or alternatively a single-column layout. Or, in general a layout with any number of columns.

The layout also includes a citations panel which displays documents which are cited by the patent. Note that the citations panel can display the cited documents in ranked order, wherein each cited documents can be ranked, for example, based upon a number of references to the cited document.

On the right-hand side of FIG. 4, the layout includes a claims panel which displays one or more claims in the patent.

Also note that the layout can include a referenced-by section (not shown), which displays other patents and other related documents which reference the patent.

The display in FIG. 4 also provides a search box for the patent, which allows a user to enter a query to search for specific terms in the patent (step 304).

The display in FIG. 4 also provides links to corresponding sections in a scanned version of the patent, wherein the sections can include: the abstract, the description, and the claims of the patent (step 306). These links enable the user to directly navigate to these sections of the scanned version of the patent.

In one embodiment of the present invention, the display also provides thumbnail versions of the drawings in the patent (not shown in FIG. 4). If a user selects on a thumbnail version of a drawing, the user interface displays an expanded version of the drawing (step 308).

In one embodiment of the present invention, the display also includes a link to a related document at the patent office web site. (See the link labeled “View Patent at USPTO” on the left-hand side of patent summary section.) This link can navigate to a corresponding version of the patent at the patent office website. Alternatively, the link can navigate to an entry for the patent on the public PAIR system at the patent office website, which enables the user to obtain the file history for the patent.

In one embodiment of the present invention, the system uses OCR techniques to extract textual data from the drawings, which is stored along with the patent. This enables the search engine to search through textual information contained within the drawings.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus comprising:
a memory to store:
information associated with a first layout and a second layout,
the first layout comprising two or more panels for presenting two or more different sections of a patent, and
the second layout comprising a single panel associated with a portion of a scanned version of the patent; and
a processor, at least partially implemented in hardware, to:
obtain patent data associated with the patent,
the patent being identified based on a search query that includes at least one term, and
the patent data including information associated with the scanned version of the patent,
store the patent data in the memory,
form a results document based on the patent data,
the processor, when forming the results document, being further to:
determine a quantity of data included in the patent data,
automatically select a layout for the results document, from the first layout and the second layout, based on the quantity of data included in the patent data,
the first layout being selected when the quantity of data satisfies a threshold, and
the second layout being selected when the first layout is not selected,
populate the selected layout based on the patent data, and
highlight occurrences, in the populated layout, of the at
least one term of the search query, to form the results document, and
provide the results document for display by a client device.

2. (canceled)

3. The apparatus of claim 1, where a panel, of the two or more panels of the first layout or the single panel of the second layout, is a contiguous two-dimensional region of a respective shape.

4. The apparatus of claim 1, where the two or more panels of the first layout comprise two or more of:
a patent summary panel which displays an abstract of the patent and information associated with the patent,
where the information associated with the patent comprises data associated with one or more of:
a patent number associated with the patent,
a filing date associated with the patent,
an issue date associated with the patent,
names of one or more inventors associated with the patent, or
a name of an assignee associated with the patent;
a citations panel which displays information associated with cited documents which are cited by the patent; or
a claims panel which displays one or more claims in the patent.

5. The apparatus of claim 4,
where the information associated with the cited documents identifies a ranked order associated with the cited documents, and
where a particular document, of the cited documents, has a respective position in the ranked order based on a corresponding number of references to the particular document in the patent.

6. The apparatus of claim 1, where the processor, when forming the results document, is further to:
include, in the results document, one or more links to one or more respective sections of the scanned version of the patent.

7. The apparatus of claim 1, where the processor, when forming the results document, is further to:
include, in the results document, a search box for the patent,
where, when the results document is provided by the client device, the search box is to receive one or more terms.

8. The apparatus of claim 7, where, based on receiving the one or more terms in the search box, occurrences of the one or more terms in the patent data are identified in the results document when the results document is provided by the client device.

9. The apparatus of claim 1, where the processor, when forming the results document, is further to:
identify a document related to the patent, and
include, in the results document, a link to the related document.

10. The apparatus of claim 9, where the link to the related document comprises one or more of:
a link to a stored version of the patent; or
a link to a document that includes information associated with the patent.

11. The apparatus of claim 1, where the processor, when forming the results document, is further to:
include, in the results document, a drawings section which comprises a thumbnail version of a drawing included in the patent,
where an expanded version of the drawing is provided for display, by the client device, based on a selection of the thumbnail version of the drawing.

12. The apparatus of claim 1, where the processor, when forming the results document, is further to:
identify one or more documents that reference the patent, and
include, in the results document, a referenced-by section,
the referenced-by section including information identifying the one or more documents that reference the patent.

13. The apparatus of claim 1, where the processor, when forming the results document, is further to:
extract textual information from one or more drawings associated with the patent, and
include, in the results document, a drawings section which includes the textual information extracted from the one or more drawings.

14-16. (canceled)

17. A method comprising:
storing, by at least one processor, information associated with a first layout and a second layout,
the first layout comprising two or more panels for presenting two or more respective sections of a patent, and
the second layout comprising a single panel associated with a portion of a scanned version of the patent;
obtaining, by the at least one processor, patent data associated with the patent,
the patent being identified based on a search query that includes one or more terms, and
the patent data including information associated with the scanned version of the patent;
determining, by the at least one processor, an amount of data associated with the patent data;
automatically selecting, from the first layout and the second layout, a layout based on the amount of data associated with the patent data,
the first layout being selected when the amount of data satisfies a threshold, and
the second layout being selected when the first layout is not selected;
forming, by the at least one processor, a results document based on the patent data and based on the selected layout,
forming the results document including:
populating the selected layout based on the patent data, and
highlighting, in the populated layout, occurrences of the one or more terms of the search query, to form the results document; and
providing, by the at least one processor, the results document for display at a client device associated with the search query.

18. (canceled)

19. The method of claim 17, where a panel, of the two or more panels of the first layout or the single panel of the second layout, is a contiguous two-dimensional region of a respective shape.

20. The method of claim 17, where the two or more panels of the first layout comprise two or more of:
a patent summary panel which displays an abstract of the patent and information associated with the patent,
where the information associated with the patent comprises data associated with one or more of:
a patent number associated with the patent,
a filing date associated with the patent,
an issue date associated with the patent,
names of one or more inventors associated with the patent, or
a name of an assignee associated with the patent;
a citations panel which displays information associated with cited documents which are cited by the patent; or
a claims panel which displays one or more claims in the patent.

21. The method of claim 20, where populating the selected layout, when the first layout is selected as the selected layout and the two or more panels include the citations panel, further includes:
including, in the citations panel, data identifying a ranked order for the cited documents,
where a particular document, of the cited documents, is positioned in the ranked order based on a number of references to the particular document in the patent.

22. The method of claim 17, where forming the results documents further includes:
including, in the results document, one or more links to one or more respective sections of the scanned version of the patent.

23. The method of claim 17, where forming the results documents further includes:
including, in the results document, a search box for the patent, where, when the results document is provided by the client device, the
search box is presented to receive one or more input terms.

24. The method of claim 23, where, based on receiving the one or more input terms in the search box, occurrences of the one or more input terms in the patent data are identified in the results document when the results document is provided by the client device.

25. The method of claim 17, where forming the results document further includes:
identifying a document related to the patent, and
including, in the results document, a link to the related document.

26. The method of claim 25, where the link to the related document comprises one or more of:
a link to a version of the patent; or
a link to a document that includes information associated with the patent.

27. The method of claim 17, where forming the results document includes:
including, in the results document, a drawings section which comprises a thumbnail version of a drawing included in the patent,
where an expanded version of the drawing is provided for display, by the client device, based on a selection of the thumbnail version of the drawing.

28. The method of claim 17, where forming the results document further includes:
identifying one or more documents that reference the patent, and
including, in the results document, a referenced-by section,
the referenced-by section identifying the one or more documents that reference the patent.

29. The method of claim 17, where forming the results document further includes:
extracting textual information from one or more drawings associated with the patent, and
including, in the results document, a drawings section which includes the textual information extracted from the one or more drawings.

30-31. (canceled)

32. A non-transitory computer-readable storage medium storing instructions, the instructions comprising:
one or more instructions, which when executed by a computer, cause the computer to store information associated with a first layout and a second layout,
the first layout comprising two or more panels for presenting two or more different sections of a patent, and
the second layout comprising a single panel associated with a portion of a scanned version of the patent;
one or more instructions, which when executed by the computer, cause the computer to obtain patent data associated with the patent,
the patent being related to a search query that includes at least one term, and
the patent data including information associated with the scanned version of the patent;
one or more instructions, which when executed by the computer, cause the computer to form a results document based on the patent data,
the one or more instructions to form the results document including:
one or more instructions to determine an amount of the patent data,
one or more instructions to automatically select a layout for the results document, from the first layout and the second layout, based on the amount of the patent data,
the first layout being selected when the amount of the patent data satisfies a threshold, and
the second layout being selected when the first layout is not selected,
one or more instructions to populate the selected layout based on the patent data, and
one or more instructions to highlight occurrences, in the populated layout, of the at least one term of the search query, to form the results document; and
one or more instructions, which when executed by the computer, cause the computer to provide the results document for display by a client device.

33-34. (canceled)

35. The apparatus of claim 1, where the processor, when obtaining the patent data, is further to:
perform an optical character recognition (OCR) operation on the scanned version of the patent to obtain the patent data.

36. (canceled)

37. The method of claim 17, where obtaining the patent data further includes:
performing an optical character recognition (OCR) operation on the scanned version of the patent to obtain the patent data.

38. (canceled)

39. The non-transitory computer-readable storage medium of claim 32, where the one or more instructions to highlight the occurrences, in the populated layout, of the at least one term of the search query, further include:
one or more instructions to visually indicate, when the second layout is selected, the occurrences of the at least one term of the search query in the portion of the scanned version of the patent.

40. The non-transitory computer-readable storage medium of claim 32, where the portion of the scanned version of the patent, included in the second layout, includes a front page of the patent.

41. The non-transitory computer-readable storage medium of claim 32, where the one or more instructions to form the results document further include:
one or more instructions to identify, when the first layout is selected as the layout for the results document, documents cited in the patent;
one or more instructions to rank the documents, cited in the patent, based on respective numbers of references to the documents in the patent; and
one or more instructions to include in a panel, of the two or more panels of the first layout, information identifying the ranked documents.

42. The non-transitory computer-readable storage medium of claim 32, where the one or more instructions to obtain the patent data comprise:
one or more instructions to perform an optical character recognition (OCR) operation on the scanned version of the patent to obtain the patent data.

43. The non-transitory computer-readable storage medium of claim 32,
where the result document includes a drawings section that includes a thumbnail version of a drawing of the patent, and
where the instructions further comprise:
one or more instructions, which when executed by the computer, cause the computer to receive a selection of the thumbnail version of the drawing, and
one or more instructions, which when executed by the computer, cause the computer to provide, for display, an expanded version of the drawing based on the selection of the thumbnail version of the drawing.
